(19) United States
(12) Patent Application Publication
(10) Pub. No.: US 2008/0021920 A1
(43) Pub. Date: Jan. 24, 2008

(54) Memory content generation, management, and monetization platform

(76) Inventors: Saul Myron Shapiro, Beijing (CN); Rosario Maria Giacobbe, Monza (IT)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/823,316

(22) Filed: Jun. 27, 2007

Related U.S. Application Data
(63) Continuation-in-part of application No. 10/811,299, filed on Mar. 25, 2004.

(51) Int. Cl. G06F 17/30

(52) U.S. Cl. 707/102

(57) ABSTRACT

Systems and methods are provided that allow for the generation, management, and monetization of memory content. Illustratively, the memory content generation and management platform comprises a computing environment comprising a memory content generation and management engine and at least one instruction set to process disaggregated data to generate and/or manage memory content. Illustratively, the instruction set comprises at least one selected memory content generation template which directs participating users to input data for processing as answers to selected questions and/or provides for the execution of a selected data scraping paradigm which illustratively operates to cooperate with a participating user's computing environment to collect digital media data (e.g., scraping e-mails, digital photos, instant message logs, etc.) for use in generating memory content. Illustratively, the generated memory content can be monetized through a cooperating user-generated advertisement platform.

### PRIORITY AND CROSS-REFERENCE

This application is Continuation-In-Part of U.S. patent application Ser. No. 10/811,299, filed Mar. 25, 2004, entitled, “INTERGENERATIONAL INTERACTIVE LIFETIME JOURNALING/DIARY AND ADVICE/GUIDANCE SYSTEM”, and claims all appropriate priority to such application and incorporates such application by reference in its entirety.

### BACKGROUND

The advent of Internet communications has availed the development of various applications and services to allow for the central storage of content for participating users. Such applications and services process varying types of content ranging from digital music, digital video, and other forms of digital data. Included among these applications and/or services are ones that address the storage and sharing of digital pictures. The commonality of these content applications and/or services allow participating users to upload various digital content and provide some context for such content—e.g., comments, descriptions, and dates.

Throughout our lives significant events, lessons, relationships, and other experiences are woven into the fabric of our lives, strand by strand. Lives pass too soon without rich and important stories, wisdom, and philosophies being passed on to children, grandchildren, and generations beyond.

Conventionally, physical and/or electronic journals are often begun with the intention of continuing them for some time. Yet we can easily become frustrated with not saying what we really want to about an experience, or forgetting the details about an important lesson learned. Too often is the case with existing practices that a participating user intends to memorialize a given experience or event, but without a clear idea of what to record. With current practices, a simple blank book, a blank document in a word processing-type computing application and/or service, or a digital media sharing computing application and/or service does not inspire one to get to the real heart of an experience.

From the foregoing it is appreciated that there exists a need for a new platform that ameliorates the shortcomings of existing practices.

### SUMMARY

Systems and methods are provided that allow for the generation and management of memory content to allow a participating user to efficiently and effectively memorialize and/or share events, experiences, and/or philosophies according to a selected context. In an illustrative implementation, the memory content generation and management platform comprises a computing environment comprising a memory content generation and management engine and at least one instruction set providing instructions to the memory content generation and management engine to process disaggregated data to generate and/or manage memory content. In the illustrative implementation, the instruction set comprises at least one selected memory content generation template which directs participating users to input data for processing as answers to selected questions and/or provides for the execution of a selected data scraping paradigm which illustratively operates to cooperate with a participating user's computing environment to collect digital media data (e.g., scraping e-mails, digital photos, instant message logs, other electronic data, etc.) and/or scraping of Internet based content (e.g., online bills, financial accounts, travel data, e-commerce data, social networking data, school data, job applications, etc.) for use in generating memory content.

In an illustrative operation, the memory content generation and management platform receives data from participating users representative of one or more portions of memory (e.g., an experience, an event, a milestone, a special date in context to an experience and/or event and/or milestone, etc.). Responsive to the data received, illustratively, the memory content generation and management engine will process the received data to generate memory content. Further, in the illustrative operation, the memory content engine can perform various operations and features on the generated memory content including but not limited to displaying, printing, navigation, storage, sharing, and/or management of the generated memory content and/or received data.

In the illustrative implementation, the exemplary memory content generation and management platform can comprise a computing application having one or more selected questions which are provided to participating users the answers of which comprise data representative of one or more portion of a memory. In an illustrative operation, through different phases of the participating user's life (e.g., over selected time intervals), the exemplary memory content generation and management platform can prompt or otherwise interactively cooperate with the participating user to prompt the participating user to input data (e.g., in the form of answers to selected questions and/or through a selected data scraping paradigm) representative of events and/or experiences (i.e., for use in generating memory content representative of specific events such as births, marriages, loss, family events, work experiences and other daily life experiences).

In another illustrative implementation, memory content generation can be based on processing data representative of yearbook, roster, directory and/or other similar type of data. In the illustrative implementation, yearbook, roster, directory and/or other similar type of data can be digitized according to one or more selected digitization processes for processing to generate memory content.

In an illustrative implementation, the received data and/or generated memory content can act as input to a user-generated advertisement platform operable to allow the generation, distribution, and management of user-generated advertisements.

Other features of the herein described systems and methods are further described below.

### BRIEF DESCRIPTION OF THE DRAWINGS

The methods and system for memory content generation and management are further described with reference to the accompanying drawings in which:

FIG. 1 is a block diagram of an exemplary computing environment in accordance with an implementation of the herein described systems and methods;

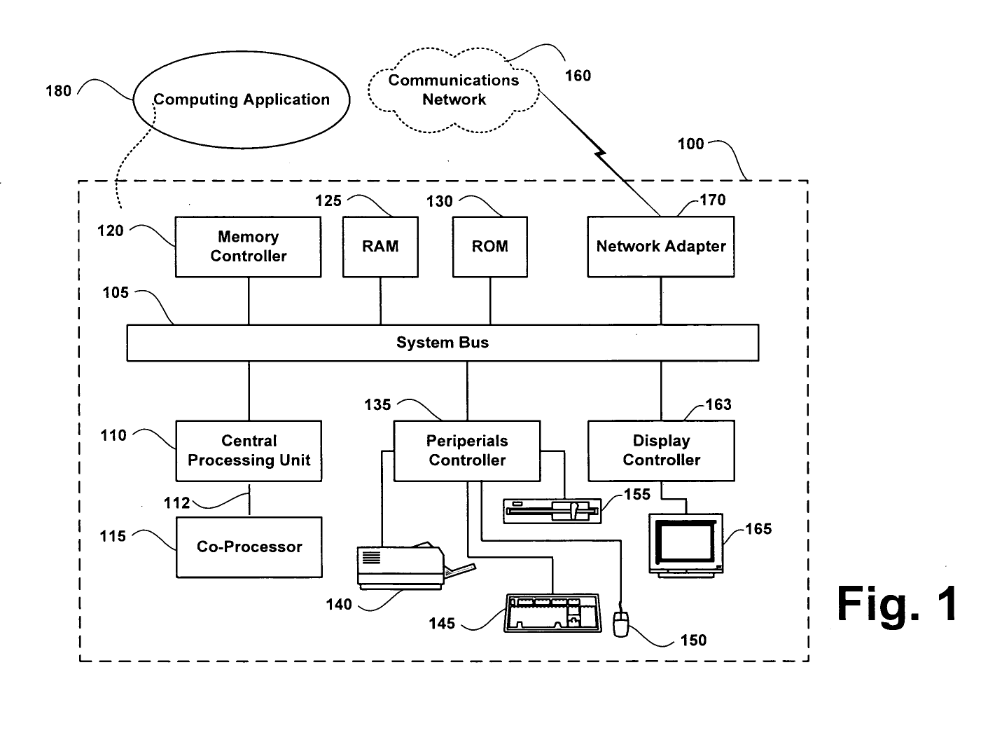

FIG. 2 is a block diagram showing the cooperation of exemplary components of an illustrative implementation in accordance with the herein described systems and methods;

FIG. 3 is a block diagram of an illustrative memory content generation and management environment in accordance with the herein described systems and methods;

FIG. 4 is a block diagram showing the cooperation of various components of an illustrative memory content generation and management environment in accordance with the herein described systems and methods;

FIG. 5 is a block diagram of an illustrative graphical user interface for use in collecting data representative of a portion of one or more memories for use in memory content generation and/or management in accordance with the herein described systems and methods;

FIG. 6 is a block diagram of an illustrative graphical user interface for use in collecting data representative of a portion of one or more memories for use in memory content generation and/or management in accordance with the herein described systems and methods;

FIG. 7 is a block diagram of an illustrative graphical user interface for use in collecting data representative of a portion of one or more memories for use in memory content generation and/or management in accordance with the herein described systems and methods;

FIG. 8 is a block diagram of an illustrative graphical user interface having an illustrative menu for exemplary operations that can be performed for use in collecting data representative of a portion of one or more memories for use in memory content generation and/or management in accordance with the herein described systems and methods;

FIG. 9 is a block diagram of an illustrative graphical user interface for use in collecting data representative of a portion of one or more memories among a group of participating users for use in memory content generation and/or management in accordance with the herein described systems and methods;

FIG. 10 is a block diagram of an illustrative graphical user interface having an illustrative menu for exemplary operations that can be performed for use in collecting data representative of a portion of one or more memories for use in memory content generation and/or management in accordance with the herein described systems and methods;

FIG. 11 is a block diagram of an illustrative graphical user interface having an illustrative menu for exemplary operations for use in managing various digital media and for collecting data representative of a portion of one or more memories for use in memory content generation and/or management in accordance with the herein described systems and methods;

FIG. 12 is a block diagram of an illustrative graphical user interface showing memory content generation in context to a selected time period in accordance with the herein described systems and methods;

FIG. 13 is a block diagram of an illustrative graphical user interface showing navigation features of an exemplary memory content generation and management computing application in accordance with the herein described systems and methods;

FIG. 14 is a flow diagram showing exemplary processing performed in connection with memory generation and management in accordance with the herein described systems and methods; and

FIG. 15 is a flow diagram showing exemplary processing performed in connection with the monetization of memory content as user-generated advertisements in accordance with the herein described systems and methods.

### DETAILED DESCRIPTION

Overview:

With current practices, generating and managing memory content is an arduous, cumbersome undertaking which renders disaggregated and disjoined data. Ultimately, the end-user is left to stitch together digital representations of memories (e.g., memory content) in a free-form manner. Furthermore, with current practices, participating users are tasked with the laborious task of inputting, categorizing, matching, and referencing various digital content representative of memories to generate comprehensive and contextually accurate memory content.

The herein described systems and methods ameliorate the shortcomings of existing practices by providing a comprehensive memory content generation, management, and monetization platform. In an illustrative implementation, the memory content generation, management, and monetization platform comprises a computing application having at least one template which prompts participating users to input data representative of one or memories as answers to a list of questions. The format of the template allows the data to be categorized, associated, referenced, and provides context to the inputted data. Such completed template(s) can then be aggregated to generate a journal or diary of memory content for a participating user. In the illustrative implementation, the exemplary computing application can illustratively operate to perform data scraping operations according to a selected data scraping paradigm. The exemplary data scraping can be performed on the participating user's computing environment and/or a participating user's accounts (e.g., personal computer, mobile phone, MP4 players, online music accounts, e-mail accounts, social networking accounts, dating website accounts, bank accounts, cable accounts, mobile phone accounts, credit card accounts, etc.) to collect data (e.g., e-mails, photos, video, audio, instant messages, journals, calendar entries, text, etc.) for use in generating memory content.

Illustrative Computer Network Environment:

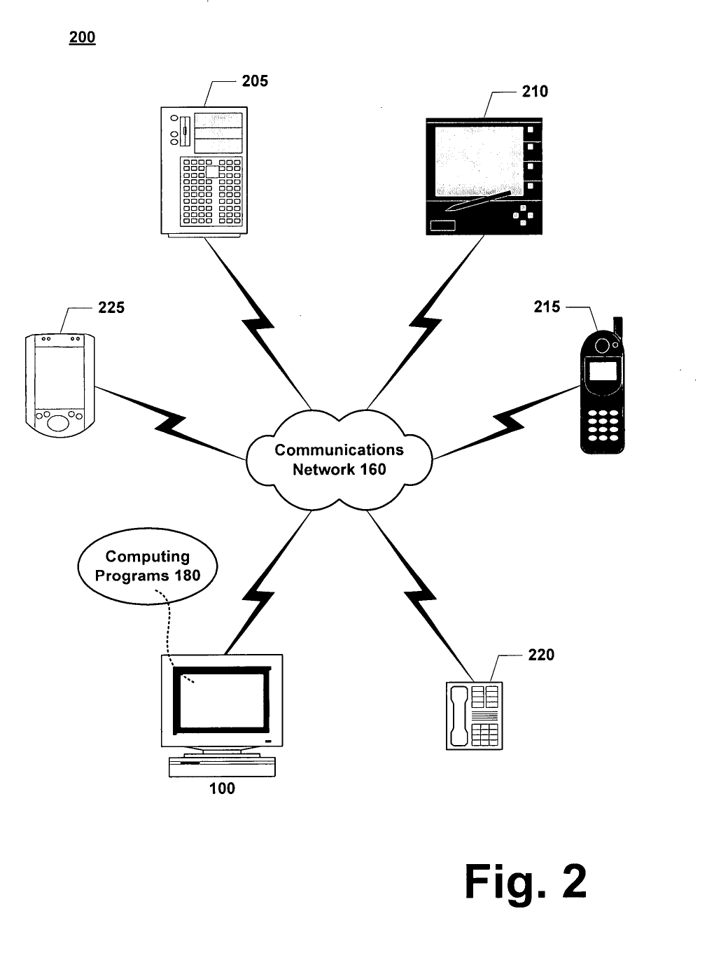

Computing system 100, described above, can be deployed as part of a computer network. In general, the above description for computing environments applies to both server computers and client computers deployed in a network environment. FIG. 2 illustrates an exemplary illustrative networked computing environment 200, with a server in communication with client computers via a communications network, in which the herein described apparatus and methods may be employed. As shown in FIG. 2, server 205 may be interconnected via a communications network 160 (which may be either of, or a combination of a fixed-wire or wireless LAN, WAN, intranet, extranet, peer-to-peer network, virtual private network, the Internet, or other communications network) with a number of client computing environments such as tablet personal computer 210, mobile telephone 215, telephone 220, personal computer 100, and personal digital assistance 225. In a network environment in which the communications network 160 is the Internet, for example, server 205 can be dedicated computing environment servers operable to process and communicate data to and from client computing environments 100, 210, 215, 220, and 225 via any of a number of known protocols, such as, hypertext transfer protocol (HTTP), file transfer protocol (FTP), simple object access protocol (SOAP), or wireless application protocol (WAP). Additionally, networked computing environment 200 can utilize various data security protocols such as secured socket layer (SSL) or pretty good privacy (PGP). Each client computing environment 100, 210, 215, 220, and 225 can be equipped with operating system 180 operable to support one or more computing applications, such as a web browser (not shown), or other graphical user interface (not shown), or a mobile desktop environment (not shown) to gain access to server computing environment 205.

In operation, a user (not shown) may interact with a computing application running on a client computing environment to obtain desired data and/or computing applications. The data and/or computing applications may be stored on server computing environment 205 and communicated to cooperating users through client computing environments 100, 210, 215, 220, and 225, over exemplary communications network 160. A participating user may request access to specific data and applications housed in whole or in part on server computing environment 205. These data may be communicated between client computing environments 100, 210, 215, 220, and 220 and server computing environments for processing and storage. Server computing environment 205 may host computing applications, processes and applets for the generation, authentication, encryption, and communication data and applications and may cooperate with other server computing environments (not shown), third party service providers (not shown), network attached storage (NAS) and storage area networks (SAN) to realize application/data transactions.

Memory Content Generation, Management, and Monetization:

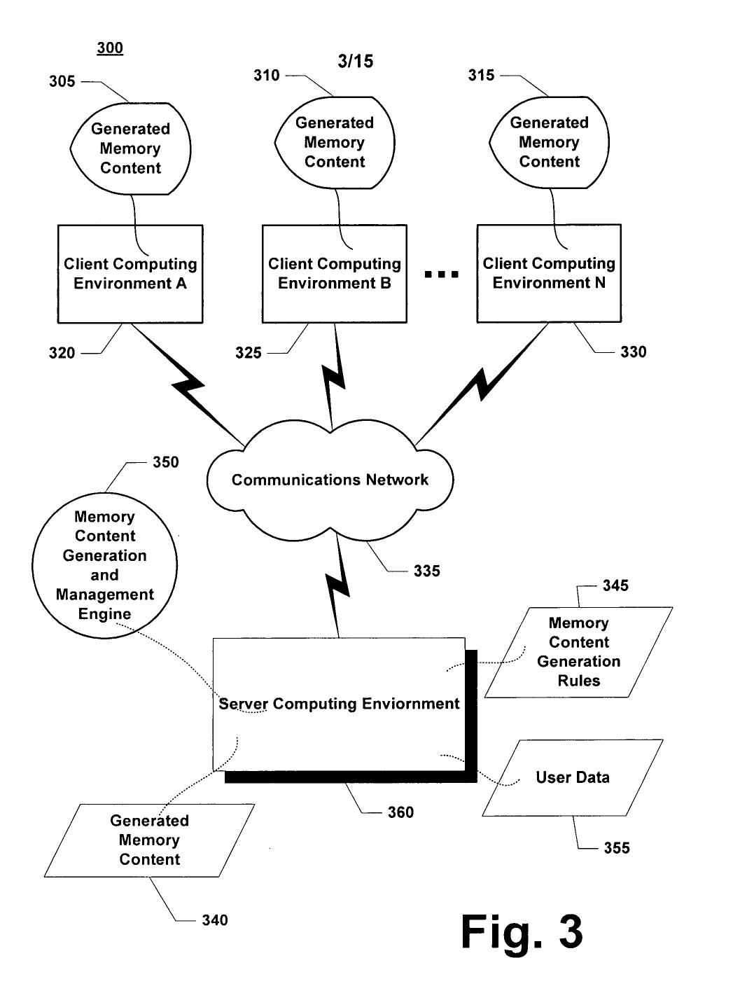

FIG. 3 shows an illustrative implementation of exemplary memory content generation and management platform 300. As is shown in FIG. 3, exemplary memory content generation and management platform 300 comprises client computing environment A 305, client computing environment B 310 up to and including client computing environment N 315, communications network 335, server computing environment 360, memory content generation and management engine 350, data storage containing generated memory content 340 and user data 335, and memory content generation rules 345. Also, as is shown in FIG. 3, memory content generation and management platform comprises generated memory content 305, 310, and 315 which can be displayed, manipulated, and/or navigated by participating users on client computing environments 320, 325, and 330, respectively. Communications network 335 can comprise one or more of fixed-wire and/or wireless intranets, extranets, and/or the Internet.

In an illustrative operation, participating users cooperating on any of client computing environments 320, 325 and/or 330 can communicate requests and/or respond to request for the generation, management, and/or monetization of memory content to/from server computing environment over communications network 335. Illustratively, responsive to a request to generate, manage, and/or monetize memory content, server computing environment 360, executing memory content generation and management engine 350, processes the request prompts the participating user to input data representative of a memory as answers to one or more memory content templates (as described further below).

Additionally, memory content generation and management engine 350, executing on server computing environment 360, can cooperate with one or more client computing environments 320, 325, and/or 330 to perform data scraping operations on one or more client computing environments 320, 325, and/or 330 to identify data representative of memories. Such data scraping can target various types of data resident on client computing environments 320, 325, and/or 330 and/or other cooperating computing environments (not shown) (e.g., cooperating web servers, computing server environments, mail servers, instant messaging servers, etc.) including but not limited to e-mails, instant message logs, digital media (e.g., photos, video, audio, text), calendar information, electronic notes, documents (e.g., paper about summer vacation), electronic bills, social networking website data, data website data, financial account data, travel data, school data, employment history data, job applications, e-commerce purchases data, and other relevant data describing, to name a few, characterizing, and/or referencing a memory.

Additionally, in the illustrative implementation, memory content generation can be based on processing data representative of yearbook, roster, directory and/or other similar type of data. In the illustrative implementation, yearbook, roster, directory and/or other similar type of data can be digitized according to one or more selected digitization processes for processing to generate memory content.

In the illustrative operation, memory content generation and management engine 350, executing on server computing environment 360, can process the participating user template driven inputted memory data and/or the data obtained from data scraping operations according to one or more memory content generation rules 345 to generate memory content 340 for communication back to participating users for display, manipulation, and/or navigation on client computing environments 320, 325, and/or 330 over communications network 335. The generated memory content 305, 310, and/or 315 can then be viewed, manipulated, navigated, and/or stored by participating users on client computing environments 320, 325, and/or 330 in cooperation with server computing environment 360. Further the generated memory content 340 can be stored for additional processing and/or subsequent use. Illustratively, responsive to a request to generate, manage, and/or monetize memory content, memory content generation and management engine 350 can prompt participating users to input user data 355 to associate participating users with generated memory content.

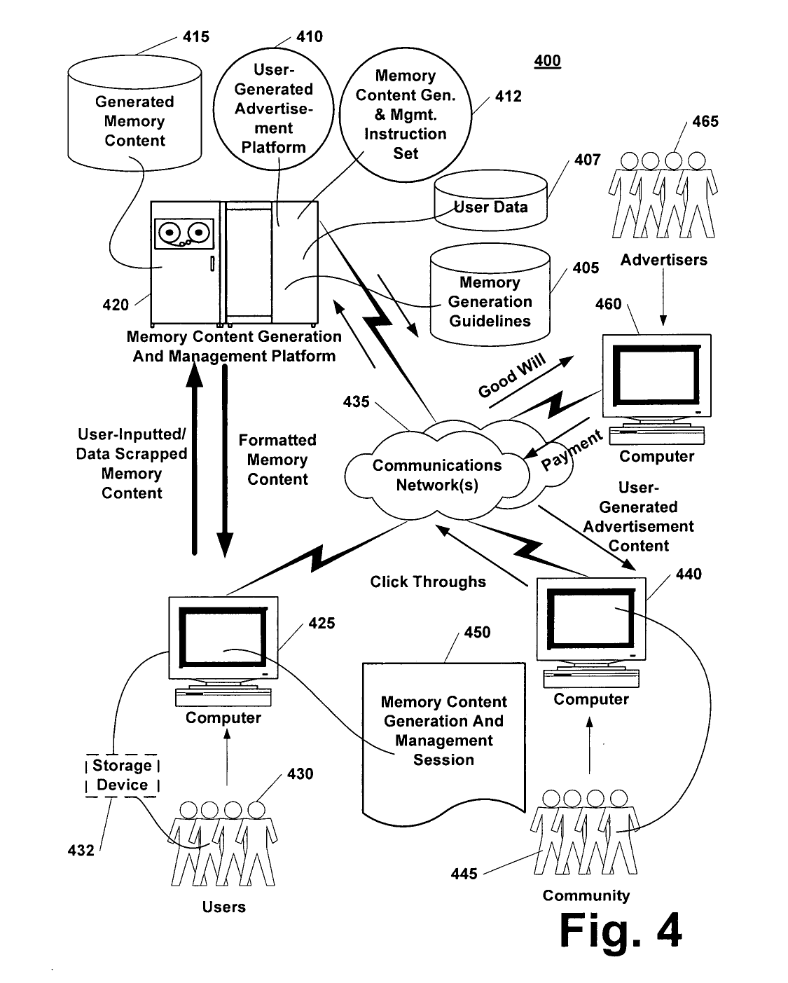

FIG. 4 shows the cooperation of exemplary components of an illustrative memory content generation, management, and/or monetization environment 400. As is shown in FIG. 4, memory content generation, management, and/or monetization environment 400 comprises memory content generation and management platform 420, operatively executing memory content generation management instruction set 412, and operatively cooperating with, user-generated advertisement platform 410, generated memory content data store 415, user data store 407, and memory generation guidelines data store 405. Further, as is shown in FIG. 4, memory content generation and management platform 420 cooperates with client computing environment 425, advertiser computing environment 460, and community computing environment 440, over communications network 435. Client computing environment operatively cooperates with participating users 430 to receive and process various input data for use in memory content generation, management, and/or monetization, including data inputted via storage device 423 (e.g., memory card, video camera, mobile phone, digital camera, MP3 player, MP4 player, flash drive, or other device capable of storing data). Advertiser computing environment 460 operatively cooperates with advertisers 465 to receive and process data representative of one or more characteristics of one or more advertising programs (including user generated advertising programs). Community computing environment 445 operatively cooperates with one or more community members to receive and/or process data representative of community feedback, community data share (e.g., community uploads of associated memory content), and/or community responses and use of advertisements.

In an illustrative operation, participating users 430 can cooperate with memory management generation and management platform 420 using client computing environment 425 over communications network 435 to initiate a memory content generation and management session 450 for use to generate and/or manage formatted memory content. As part of a memory content generation and management session 450, memory content generation and management platform 420 can prompt participating users 430 to input through cooperation with client computing environment 425 data responsive to one or more memory content creation, management, and/or management templates (i.e., as derived from memory generation guidelines 405) using an exemplary graphical user interface (not shown) (e.g., web browser). Additionally, memory content generation and management platform 420 can cooperate with client computing environment 425 to perform one or more data scraping operations according to one or more selected data scraping paradigms to identify and retrieve data for use in memory content generation. Such data can include but is not limited to e-mails, digital media (audio, video, photos, and text), calendar entries, journal entries, and documents (e.g., school report on a summer vacation). Such scraped data can be used alone or in combination with user inputted memory to generate formatted content (e.g., formatted content that can be subsequently categorized, indexed, and/or searched to facilitate users' experience in managing memory content).

In the illustrative operation, memory content generation and management platform processes memory data (i.e., inputted data) received from participating users and/or scrapped from client computing environment 425 (and associated storage devices 432) according to one or more memory content generation and management instructions 412 to generate memory content for communication back to client computing environment 425 for display, navigation, manipulation, and/or storage by participating users. Additionally, generated memory content can be stored by memory content generation and management platform 420 on generated memory content data store 415 for additional processing for subsequent use.

Further, in the illustrative operation, generated memory content can be used to generate user-generated advertisements. Illustratively, memory content generation and management platform 420 can operatively cooperate with user-generated advertisement platform 410 to process data (e.g., generated memory content, scraped data, and/or user inputted memory content) to generate user-generated advertisements according to one or more preferences provided by participating users 430. Illustratively, user-generated advertisement platform 410 can operatively cooperate with advertiser computing environment 465 over communications network 435 to obtain threshold requirements that can be set by participating advertisers for user-generated advertisements. Additionally, user-generated advertisement platform can operatively cooperate with community computing environment 440 (and community participants 445) over communications network 435 to obtain data representative of the usage of user-generated advertisements. Memory content based user-generated advertisements can be generated in various manners including but not limited to, initiated by a participating user and/or responsive to an advertiser request for a an advertisement. The user-generated advertisement can generate revenue according to one or more commission revenue sharing models which calls for the sharing of revenue by participating users who generate advertisements with advertisers and/or community users as proscribed by user-generated advertisement platform 410.

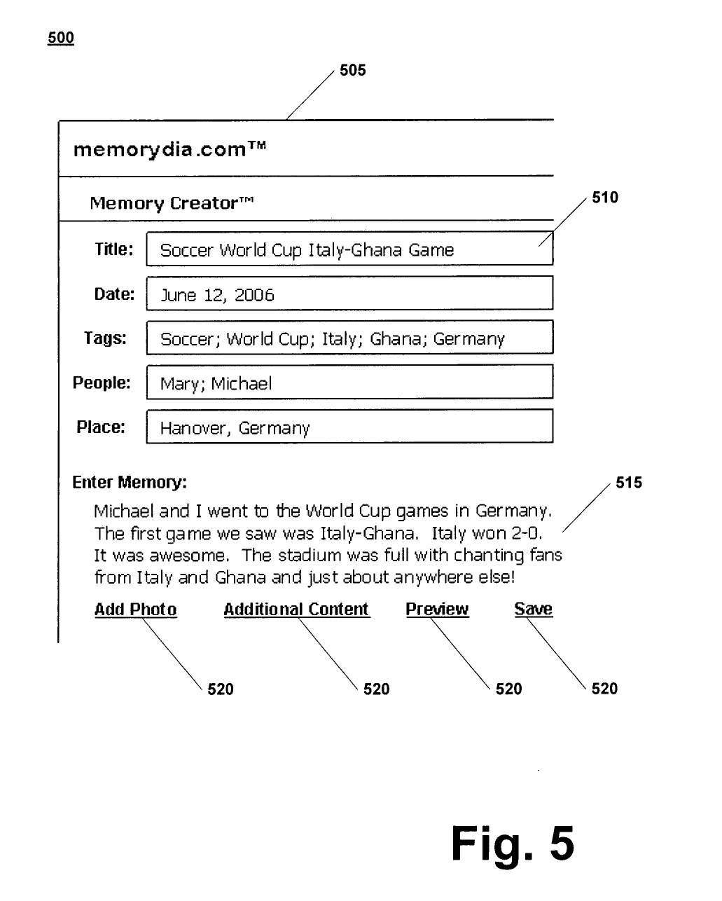

With references to FIGS. 5-11, in an illustrative implementation, the generation, management, and/or monetization of memory content can take several forms and can be applied to several types of memory content. In the illustrative implementation, a participating user can register and log onto memory content generation and management platform 400 of FIG. 4. Responsive to a participating user logging in, platform 400 can operatively present the participating user (i.e., through client computing environment 425), with various options (and several sub-options) for the generation, management, and/or monetization of memory content. Such options include but are note limited to: populating a memory content creation form, populating a memory journal form (e.g., different selected format for memory content), populating a memory content prompt form, populating a digital media (e.g., photos, audio, text, video) form, populating a memory content form representative of a group memory, and populating a memory content form representative of event-type memories.

FIG. 5 shows a graphical user interface environment 500 for use in capturing memory data from participating users in accordance with the illustrative operations described in FIGS. 3 and 4. As is shown graphical user interface environment 500 comprises display/navigation pane 505 having one or input fields 510 that prompt participating users (not shown) to input data representative of a memory for use in memory content generation. Additionally, display/navigation pane comprises free-form data input portion 515 that allows participating users to associated data to the template driven input field data. Further, as is shown in FIG. 5, display/navigation pane 5050 comprises navigation/menu commands 520 that allow participating users to execute additional selected features and/or operations to append additional data to inputted memory content and/or to perform data manipulation/storage operations on inputted and/or saved memory content.

In the illustrative implementation, the memory content creation form as illustratively illustrated in FIG. 5 operatively prompts participating users to input different pieces of information that make it possible to identify and later recall a memory (or set of memories). In the illustrative implementation, the form can comprise various user prompts for information including but not limited to: title, date (e.g., memory date), tags (e.g., memory attributes—identifiers that can be used later to search for the memory content), people who were part of the occurrence described in the memory, and location where the memory occurred. Further, the exemplary memory content creation form can comprise a portion where the participating user is prompted to input a description of the memory as well as navigation/menu tools for the participating user to perform selected functions regarding the memory being inputted. Such selection function illustratively include but are not limited to: adding digital media to the inputted memory (e.g., audio, video, photos, text), adding non-memory specific content to the inputted memory (e.g., news, horoscope, weather, lottery numbers, etc. of the day when the memory is created), allowing the participating user to preview the created memory, and allowing the participating user to save the created (generated) memory (e.g., in generated memory content data store 415 of FIG. 4).

In the illustrative implementation, the memory creation form of FIG. 5 can also be deployed as a memory journal form. Illustratively, the memory journal form maintains the same input prompts and offers the same features and operations of the memory creation form. Additionally, the memory journal form can operate to capture daily memories (e.g., what happens in the user's life as each day goes by). In an illustrative operation, the memory journal form can be automatically populated with the date information of the day in which a participating the user has opened the exemplary memory journal form and be automatically assigned one or more tags that identify the memory with the date (e.g., day, month, year, season, etc.).

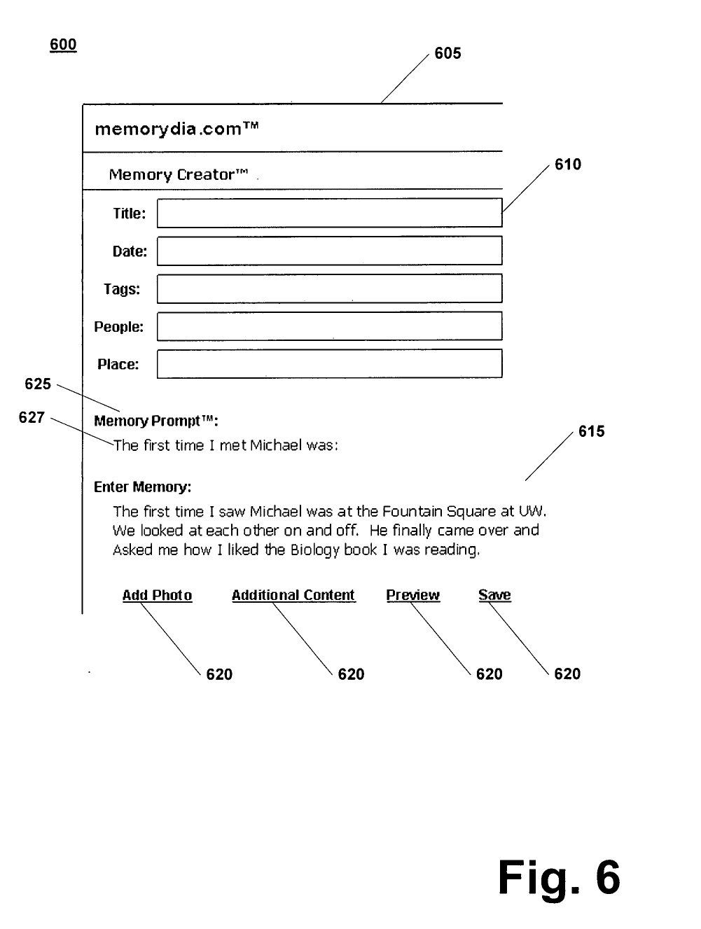

FIG. 6 shows another graphical user interface environment 600 having exemplary display/navigation pane 600. As is shown in FIG. 6, display/navigation pane 605 comprises input fields 610, free-form data entry portion 615, and navigation/menu commands 620 for use in performing additional operations and/or features to memory content. Additionally, as is shown in FIG. 6, display/navigation pane 605 further comprises a memory prompt portion 625. Illustratively, memory prompt portion 625 can direct a participating user (not shown) to enter data according to the presented prompt 627 to facilitate the inputting of data relevant to a particular memory. As is illustratively shown, memory prompt portion 625 provides memory prompt 627 directing the participating user (not shown) to enter data in free-form data entry portion 615 representative of “The first time I saw Michael was:”. In having memory prompts, the user experience in identifying data for inputting for a particular memory is facilitated.

In an illustrative implementation, the memory prompt represented in FIG. 6 can present participating users with a set of questions (prompts) that are tied to a the participating user's life stage (i.e., to ensure the relevance of memory prompts, memory content generation and management platform of FIG. 4 can illustratively operate to match a participating user to one of a selected set of life stages including but not limited to, Life Stage 1: Childhood Memory. From conception to birth to the beginning of the school experience, Life Stage 2: School Year Memory. School days: kindergarten, middle school and high school, Life Stage 3: “On My Own” Memory. First time on my own, including the college years, the first apartment/house, housework, finances and relationships, Life Stage 4 Family Memory The Family, from the first time together as a couple, to commitment to each other, to parenting, 5. Life Stage 5: “On My Own Again” Memory. On my own again: when adults become empty-nesters or go from being a spouse/partner to the opportunities/excitement/struggles of building a new life on their own, and Life Stage 6: Before I go Memory. Aging and dealing with the notion of upcoming death, natural or premature, and the desire to pass on memories to those who survive us.

In the illustrative operation, memory prompts can be designed to guide participating users through various parts of their lives, asking them relevant questions whose answers become generated memory content. Operatively, some prompts may be in the form of leading statements rather than be full questions. For example, memory prompt questions can include but are note limited to:
What was your first car?
Who was your best friend in high school?
The first time Michael and I met was:
How I first told Michael that I was pregnant was:

In an illustrative operation (and as is shown in FIG. 6) a participating user can be presented with the memory prompt form which is similar in design to memory creation form of FIG. 5, having additional that in the bottom part of the form, above the label “Enter Memory”, there will be space for the question contained in the provided memory prompt. As is shown in FIG. 6, below the “Enter Memory” (615) section is a dynamic set of navigation/menu commands. Operatively, if the participating user has entered his/her answer in the text box under the “Enter Memory” label (615), a first set of selected navigation/menu commands will be provided to the participating user. “Add Photo” (which lets the user associate a photo to given memory), “Additional Content” (which lets users add other types of content to the memory content, such as news, horoscope or weather of the day when it was created, or music that the participating user may choose), “Preview” (which lets the participating user to view the appearance and display properties of the generated memory content), and “Save” (which allows for the storage of the generated memory content).

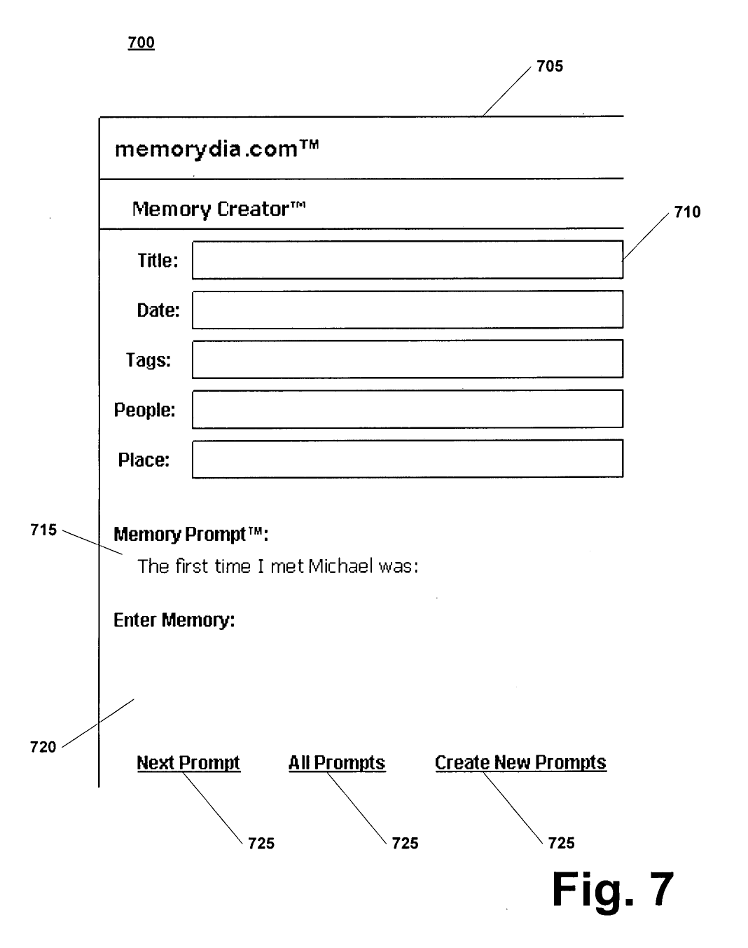

FIG. 7 shows another exemplary graphical user interface environment 700. As is shown, exemplary graphical user interface environment 700 comprises display/navigation pane having various input fields 710, memory prompt portion 715, free-form data entry portion 720, and navigation/menu commands 725. In the illustrative operation, if the participating user has not entered his/her answer in the text box under the “Enter Memory” label 715, a second set of navigation/menu command will be displayed to the participating user: “Next Prompt” (which lets the participating user to skip the presented memory prompt and move to the next memory prompt), “All Prompts” (which lets the participating user to view available memory prompts for a given life stage, and “Create New Prompt” (which brings launches supporting functions to allow for the creation of a custom memory prompt allowing participating users to create as new memory prompts). Additionally, in the illustrative operation, when a memory prompt is presented to the participating user, memory content generation and management platform 420 of FIG. 4 can operate to add one or more memory content forms (e.g., memory creation form) links to other associated memory content and/or links to advertisers (e.g., user generated advertisements based on memory content).

Additionally, the exemplary interface described in FIG. 7 can comprise one or more interface/navigation/display operations and facilities to allow participating users to upload photographs (not shown) for association with desired memory content. Such operations and/or facilities can, illustratively, allow users to include various digital media photographs from a variety of sources (e.g., digital camera, cooperating computing applications for use in processing digital media, mobile phone, mobile personal digital assistant, and/or generic digital media files).

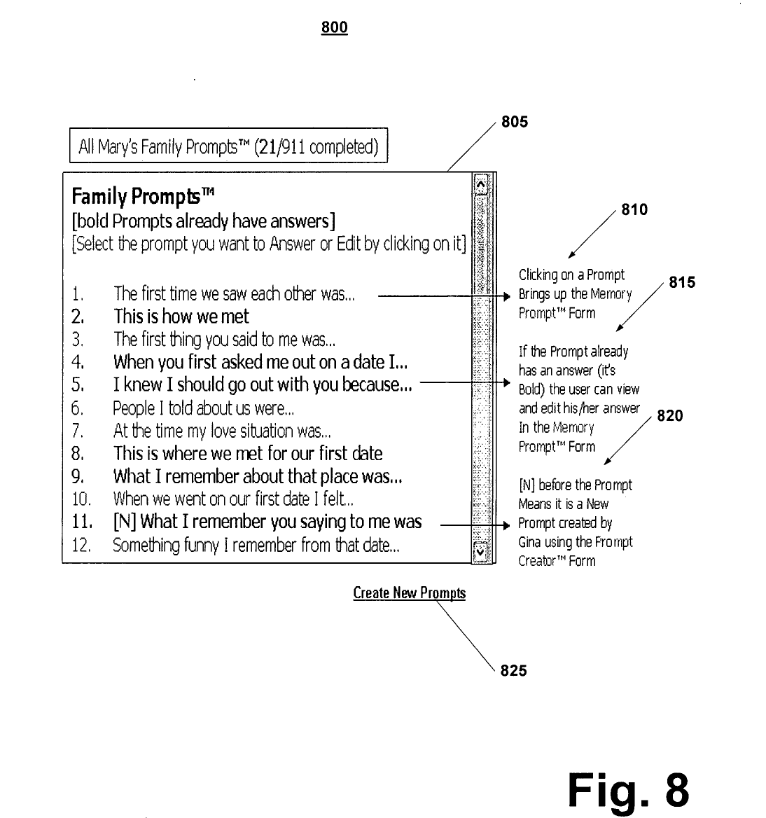

In the illustrative operation, if the participating user selects “All Prompts”, a display/navigation pane 805 of FIG. 8 can be launched displaying a continuum of available memory prompts for the participating user's life stage as is shown in graphical user interface environment 800 of FIG. 8. Depending on whether the participating user has already encountered a particular memory prompt, the display/format of the memory prompt may be different (e.g. a memory prompt can be in normal text or in bold 815, where bold text can be used illustratively to signify that the participating user has already stored an answer to that particular memory prompt as memory content).

In the illustrative operation, clicking on a normal text (not yet answered) 810 memory prompt can operate to launch a memory prompt form allowing the participating user to enter an answer. Clicking on a bold text (already answered) memory prompt can also operate illustratively to launch the memory prompt form but the user's answer can be displayed after the “Enter Memory” label and the user can be allowed to edit the memory entry. Additionally, in the illustrative implementation, an indicator can be used (e.g., [N]) to describe whether a prompt was a customized prompt 820. Further, new memory prompts can be created using navigation/menu command 825.

In the illustrative implementation, participating users can also elect to execute a random memory prompt feature, whereby memory content generation and management platform (420 of FIG. 4) can illustratively operate to select a random memory prompt from a population of memory prompts for a specific for display and/or navigation by the participating user. In an illustrative operation, the participating user can continue to execute the random memory prompt feature by issuing a “Next Prompt” command until the participating user identifies a random memory prompt that the user wishes to answer to generate memory content.

In the illustrative implementation, memory links can operatively provide participating users with links to relevant content on other data sites (e.g., Web Sites). For example, a memory prompt describing a vacation may contain links to correspondent vacation spots, geographical maps, time zone information or exchange rate sites. Illustratively, relevancy of the memory links can be set by a correspondent memory prompt and by the participating user's answer that creates the Digital Memory.

In the illustrative implementation, memory advertisements can comprise text advertisements, sponsored links, display advertisements, and/or user-generated memory content advertisements that can be sold by the operator of memory content generation and management platform to cooperating advertisers in an effort to make the advertisements accretive to the a participating user experience and associated to the topic being discussed in inputted memory data.

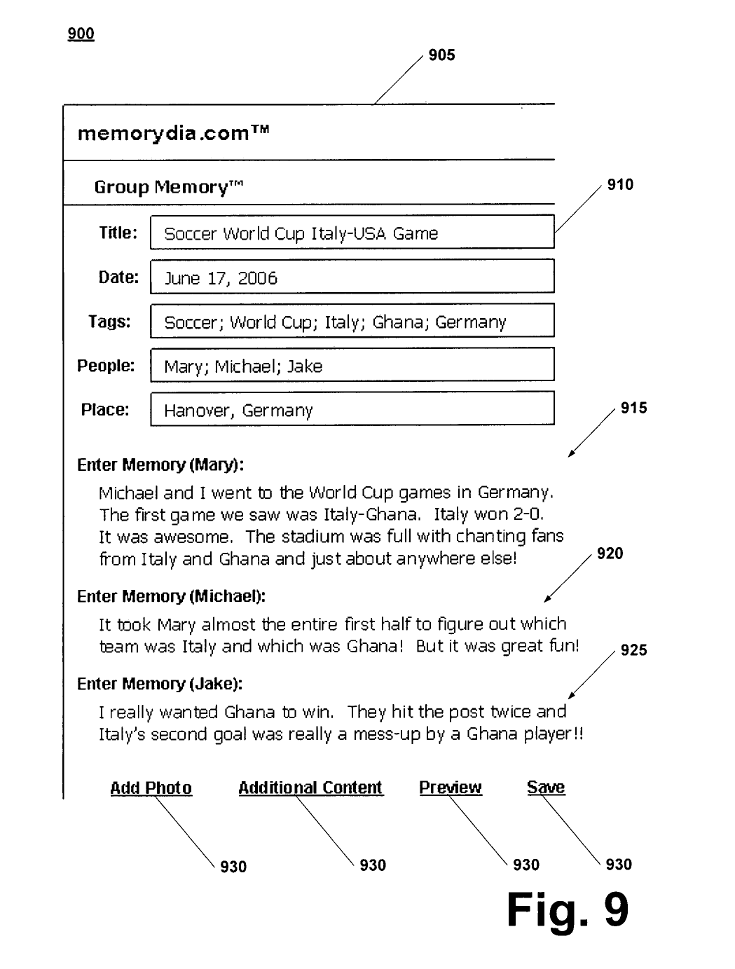

FIG. 9 shows another exemplary graphical user interface environment 900. As is shown in FIG. 9, graphical user interface environment 900 comprises display/navigation pane 905 having memory data input fields 910, and one or more portions to allow a group of participating users to enter free-form memory content as represented by 915, 920, and 924 respectively. Further, display/navigation pane 905 comprises navigation/menu commands 930 for use in performing additional features/operations on the inputted data. In an illustrative implementation, a group memory form can be presented to participating users listing the participating users that have/should contribute to the generation of memory content. In an illustrative operation, a label is generated to indicate which portion of the inputted memory content was created by which of the participating cooperating users.

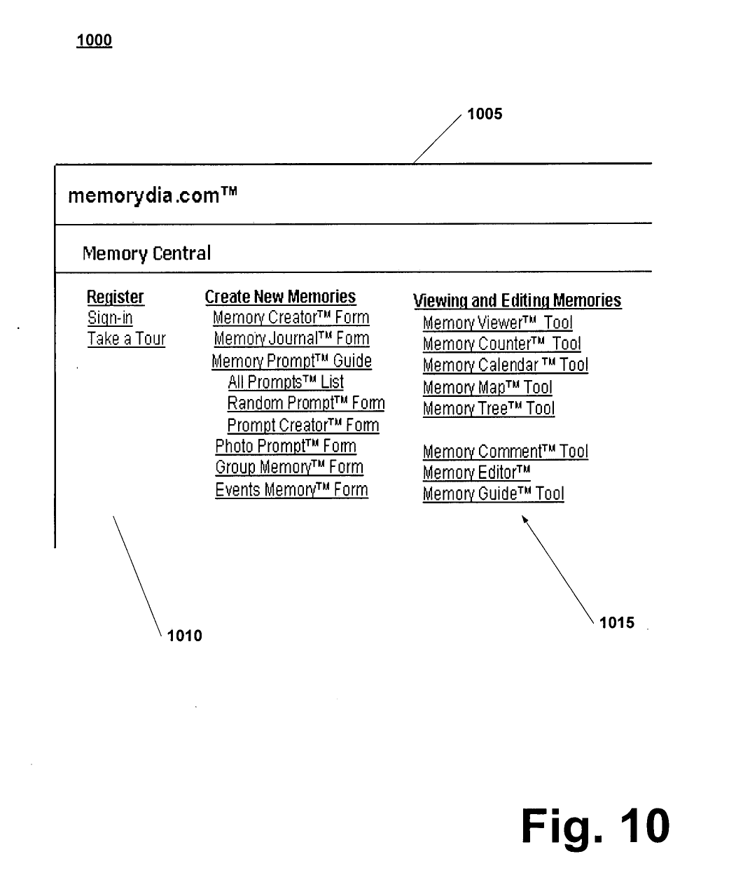

FIG. 10 shows another exemplary graphical user interface environment 1000. As is shown, in FIG. 10, exemplary graphical user interface environment 1000 comprises display/navigation pane 1005 comprising display area 1010 and various navigation/menu commands 1015 for use creating, viewing, and editing memory content. In an illustrative implementation, navigation/menu commands 1015 can include but are not limited to, a memory map tool that allows participating users to view memories on a geographical map. Memory content generation and management platform (420 of FIG. 4) can operate to adjust the map to be of the world or of a specific region based on the locations indicated by the participating user found in the “place” input field of completed and saved memory content creation forms. For example, if the “place” input field lists the United States for each completed/saved memory content creation form, the map presented to the participating user by memory content generation and management platform will be of the United States. However, if the “place” field is populated with other geographical locations other than the United States, the map presented to the participating user by memory content generation and management platform will be of the world. In an illustrative operation, participating users can have the ability to zoom into particular regions on the map to view the number of generated memories in a given region, and to further zoom into the map to view generated memory content displayed graphically over the map.

Another illustrative feature/operation provided by graphical user interface environment 1000 can include a memory tree tool that allows participating users to view memories on genealogical tree image. Memory content generation and management platform can process user registration information to determine relationships between participating users (e.g., father, son, mother, daughter, etc.) and matching related persons using a “people” input field of completed/saved memory creation form to generate a genealogical tree.

Another illustrative feature/operation provided by graphical user interface environment 1000 can include a memory import tool that allows participating users to import other people (e.g., memory buddies) who generated memory content relating to the participating user. In an illustrative operation, the importation of other people participating users should be assigned selected privileges by their memory buddy.

Another illustrative feature/operation provided by graphical user interface environment 1000 can include a memory comment tool that allows participating users to view other people's generated memory content and to add comments to them that can be stored with the same generated memory content. In an illustrative operation, to add a comment to a memory buddy's memory content, a participating should be provided access privileges by the participating user having ownership of the commented memory content.

It is appreciated that although FIG. 10 describes illustrative features and operations that such description is not exhaustive as the herein described systems and methods contemplate various features and operations that can be performed in the creation, viewing, and editing of memory content.

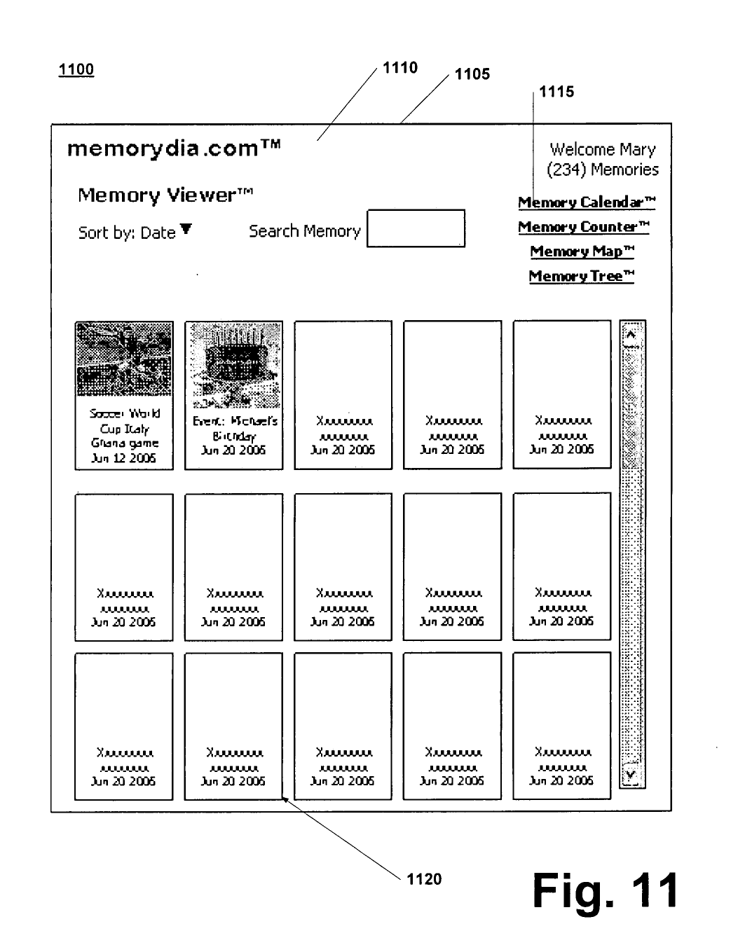

FIG. 11 shows another exemplary graphical user interface environment 1100. As is shown in FIG. 11, exemplary graphical user interface environment 1100 comprises display/navigation pane 1110 having display portion 1105, navigation/menu commands 1115, and graphical representations of memory content 1120 having various information about the memory content. In an illustrative implementation, the memory viewer tool allows participating users to view generated memory content in a concise and efficient manner. In the illustrative implementation, memory content can be displayed with their title, date, and when available a photo (or other additional content). In an illustrative operation, participating users can navigate through the memory viewer tool to select memories to open to allow the participating user to perform one or more functions on the memory content including but not limited to editing, sharing, and/or printing the memory content.

In the illustrative operation, the memory viewer tool can allow participating users to sort memory content by title, date, people, place, memory type, and/or a custom view which the participating user can create using the memory viewer tool. Additionally, in the illustrative operation, participating users are allowed a search facility to allow the participating users to search for memory content using one or characteristics of the memory content including but not limited to tags, full keywords, and/or meta data associated with the memory content.

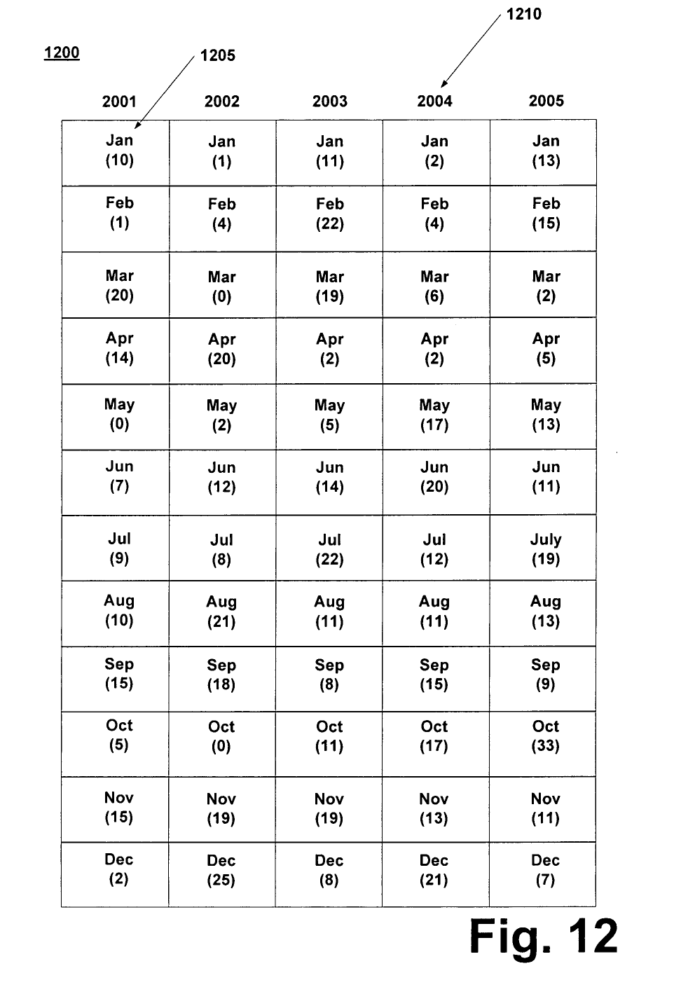

FIG. 12 shows another exemplary graphical user interface environment 1200. As is shown in FIG. 12, exemplary graphical user interface environment comprises calendar 1205 delineated in a selected increment 1210 such that the selected increment has a display of the number of memory content generated on that increment. In an illustrative implementation, the memory calendar tool as described by FIG. 12 allows participating users to view generated memory content along a memory timeline which, illustratively, can be a continuum divided by calendar year showing a graphical representation of memories in a selected increment (e.g., each month) along with a number that identifies the number of generated memory content on that increment (e.g., each month).

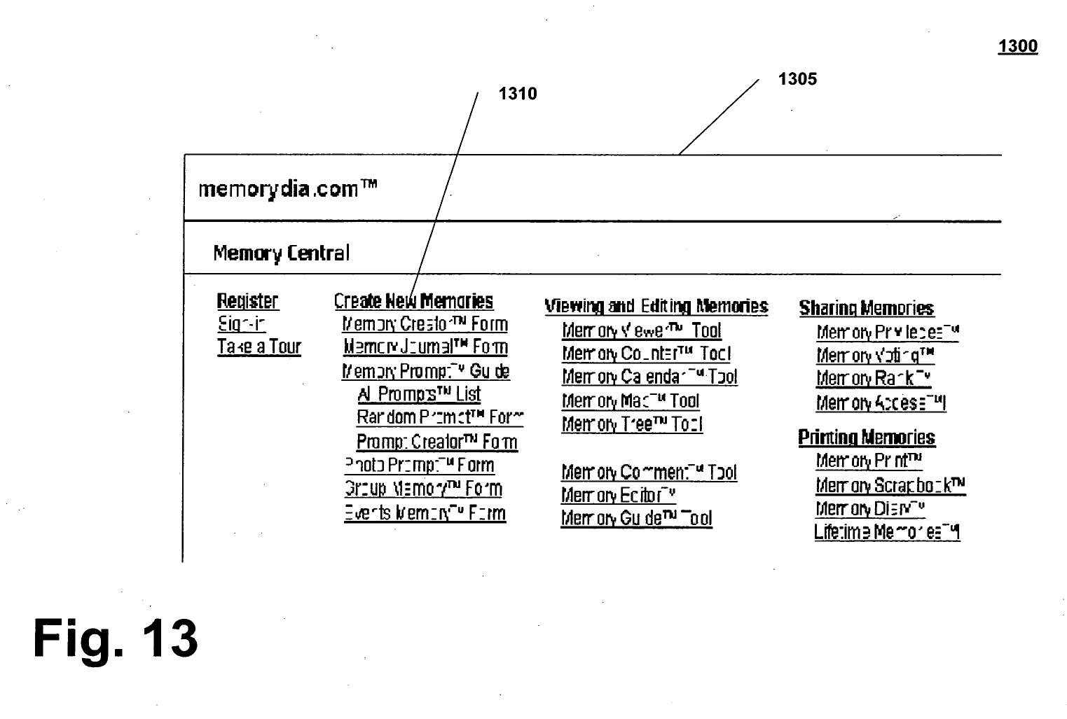

FIG. 13 shows another exemplary graphical user interface environment 1300. As is shown in FIG. 13, exemplary graphical user interface environment 1300 comprises display/navigation pane 1305 having various navigation/menu commands 1310 for use in creating, viewing/editing, and sharing generated memory content. In the context of sharing generated memory content, memory content generation and management platform 420 allow participating users to shares memory content with other participating users as part of a memory share operation. In an illustrative implementation, sharing generated memory content can be based on privileges that can be assigned to other participating users (e.g., memory buddies) according to a selected privileges paradigm that sets forth one or more guidelines for memory content generation and management platform 420 in the assignment of privileges. In the illustrative implementation, participating users can contribute to the guidelines set forth in the privileges paradigms. In an illustrative operation privileges can determine what participating user can do to memory content for a memory buddy including but not limited to, viewing generated memory content generated by a memory buddy, generating memory content for a memory buddy, editing memory buddy's memory content or adding to memory content for a memory buddy, importing memory buddy's memory content, adding comments to a memory buddy's memory content, and voting on a memory buddy's memory content to create a rating for a particular memory content. In the illustrative implementation, the sharing operation allows participating users to share memory prompts with memory buddies through a prompt share function.

Additionally, the features and operations described in FIG. 13 further include memory content printing and creating scrap books operations. In the illustrative operation, memory content generation and management platform (420 of FIG. 4) allows participating users to print memory content using a memory print operation. In the illustrative implementation, the memory print operation allows participating users to illustratively print individual memories, groups or memories, or scrap books which create a collection of memory content.

Furthermore, although not shown in FIG. 13, memory content generation and management platform allows illustratively for the operation of a community operation. In an illustrative implementation, the community operation allows participating users to search for other participating users by searching other participating users' generated memory content. In an illustrative operation, the search can be performed specific participating users' memory content (e.g., find Mary Jones' memory content) or by searching for memory content using selected memory content identifiers such as title, date, people, place, or tags (e.g., find memory content about the 2006 Soccer World Cup). The search feature also allows for participating users to search for other participating users using identification information about a particular participating user.

In the illustrative operation, a participating user can search for other participating users who have elected to share their memory content (i.e. they have granted memory access to other participating users). Such privileges can be conferred to other participating users according to one or more group designations including but not limited to, all users or specific memory buddies.

In the illustrative operation, participating users can also determine which memory content to make available for sharing (e.g., all memory content or assigned memory content depending on one or more criteria including relationship, proximity, interests, common experience, or other affinities). For example, Mary Jones may give her husband Michael access to all of her memory content, but give her children access to only a subset of her memory content. She may further decide of take a few of her memory content and give access to them to all users, or she may decide to let all users see that she has stored memory content, but require them to contact her to receive privileges to interact with those memory content.

In the illustrative operation, the memory search functionality can also allow participating users to search for their ancestors and get access to their memory content. For example, Mary Jones could do a search for memory content related to the place where she knows her great-grandfather came from (e.g., “place” input field of a memory creation form), with the additional attribute of his name and date of birth. Once ancestors are found, they can be added to the participating user's memory tree.

Another aspect of the community functionality allows participating users the ability to search for other users who have had like experiences (as captured in their memory content), or who have created and shared memory content related to activities or experiences they want to experience or have. For example, a user can leverage other user's memory to plan events, activities or trips that were created around a place they plan to go to, or they can contact them through memory content generation and management platform to ask for specific advice or directions.

The herein described systems and methods can be further extended to generate corporate memory content. In this context, corporate memory content relate to memories developed at the work place. In an illustrative implementation corporate memory content can be integrated into the email (e.g., MICROSOFT OUTLOOK®) or information sharing system (e.g., Microsoft SharePoint) used by companies to create and track memories related to work activities.

In an illustrative operation, memory content generation and management platform (420 of FIG. 4) can also be used to create a corporate record of events and leisure activities involving corporate workers. For example, company meetings, company picnics, sales meetings, corporate events, trade shows, etc., can be presented for display and navigation to allow participating corporate users the ability to leverage the available functionality provided by the platform (e.g., comments, group memories, prompts, etc,) to create a complete corporate memory content of a given event.

In the illustrative implementation, corporate memory content generation and management can allow a corporation to collect historical events in an organized manner for later use in the production of anniversary, associate retirements or similar milestones. The corporate memory content feature can also be used as a corporate repository for communication or information. For example, corporate memory content can be created by retailers to prove to product manufacturers, or intra-company departments that point-of-sale promotional and marketing material, such as end-caps or specific displays, have been deployed on their floor space according to the manufacturers' terms and conditions. In such case, the retailer can create a corporate memory content with a photo of the end-cap or display, store it on the platform and give the appropriate contact at the manufacturer's headquarters privileges to access the corporate memory content via the platform. These records can also be supplemented with project-specific memory prompts, such as promotion or event name, date and time of compliance, associate name, date of receipt of materials, complete checklist of point-of-sale materials, etc.

It is appreciated that although FIG. 13 describes illustrative features and operations that such description is not exhaustive as the herein described systems and methods contemplate various features and operations that can be performed in the creation, viewing, and editing of memory content.

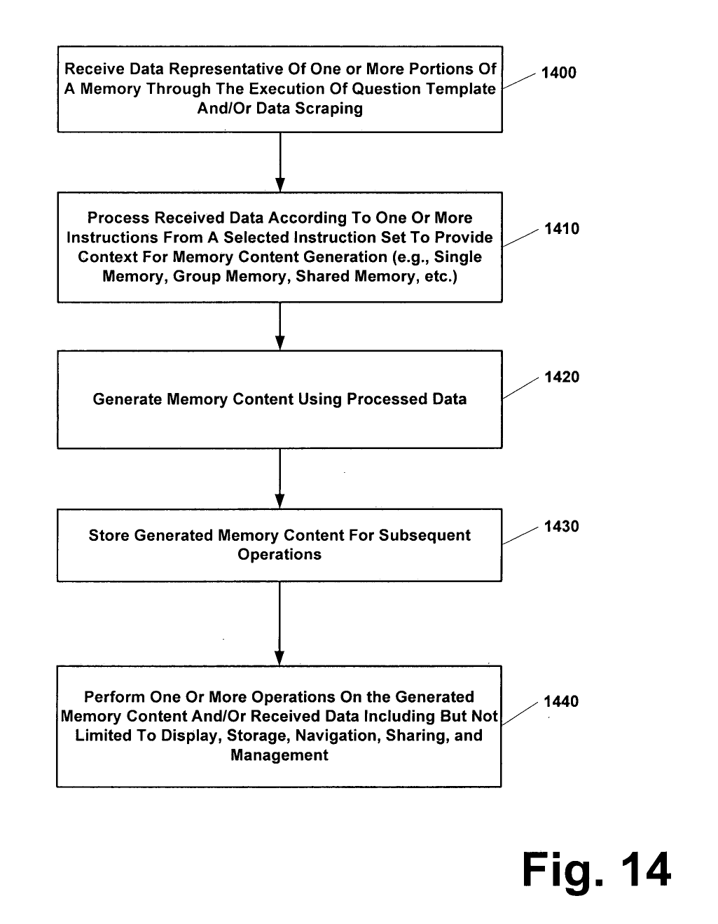

FIG. 14 is a flow chart showing exemplary processing performed in connection with generating, managing, and/or monetizing memory content. As is shown in FIG. 14, processing begins at block 1400 where data representative of one or more portions of a memory is received trough the execution of a question template and/or data scraping operations. Processing then proceeds to block 1410 where the received data is processed according to one or more instructions from a selected instruction set to provide context for memory content generation (e.g., single memory, group memory, shared memory, comment, prompt, etc.). Memory content is then generated at block 1420. The generated memory content is then stored for subsequent operations at block 1430. From there processing proceeds to block 1440 where one or more operations can be performed on the generated memory content and/or received data including but not limited to display, navigation, sharing, and management.

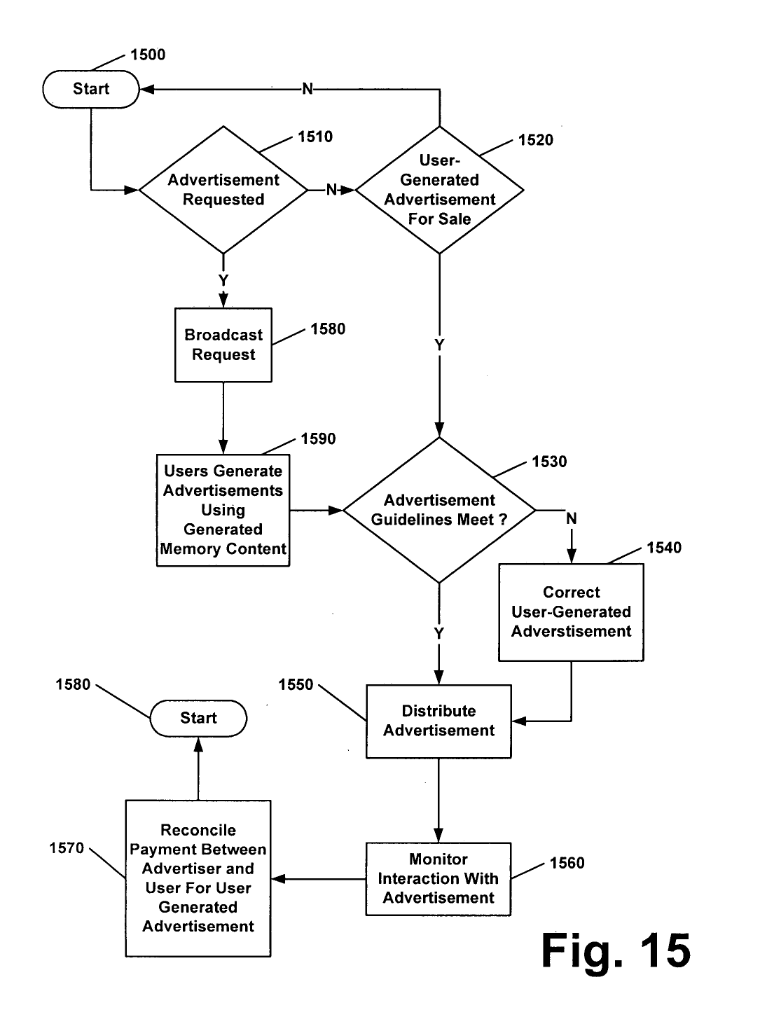

FIG. 15 shows exemplary processing performed when generating user-generated advertisements. As is shown in FIG. 15, processing begins at block 500 and proceeds to block 510 where a check is performed to determine whether a user-generated advertisement is being requested. If the check at block 510 indicates that an advertisement is not being requested, processing proceeds to block 1520 where a check is performed to determine whether a user has a user-generated advertisement for sale (or distribution) to potential advertisers. If the check at block 1520 indicates that there is user-generated advertisements for sale, processing proceeds to block 1530 where a check is performed to determine whether the user-generated advertisement meets advertisement guidelines. If the check at block 1530 indicates that the user-generated advertisement does not meet advertisement guidelines, processing proceeds to block 1540 where the user is afforded the opportunity to bring the user-generated advertisement in line with the advertisement guidelines. Processing proceeds to block 1550 where the advertisement is distributed for consumption by other participating users by one or more advertisers (e.g., such advertisers can be contacted by an exemplary advertisement services operator acting as a broker between users generating advertisements for products/services that users find interesting and advertisers who cooperate with the advertisement service operator to obtain new advertisements). From there, interaction with the user-generated advertisement is monitored at block 1560 to determine the payment to be made to the user. Such payment can be based on one or more monetization guidelines. Processing then terminates at block 1570.

However, if the check at block 1530 indicates that the user-generated advertisement meets selected advertisement guidelines, processing proceeds to block 540 and continues from there. If the check at block 1520 indicates that there is no user-generated advertisement for sale, processing reverts to block 1500 and proceeds from there. If the check at block 1510 indicates that a user-generated advertisement is being requested, processing proceeds to block 1580 where a request is made to participating users to generate advertisements for a particular product/service for the requesting advertiser. The advertisement is then generated at block 1590 by participating users for consumption by the advertisers and other participating users. From there processing proceeds to block 530 and continues from there.

It is understood that the herein described systems and methods are susceptible to various modifications and alternative constructions. There is no intention to limit the herein described systems and methods to the specific constructions described herein. On the contrary, the herein described systems and methods are intended to cover all modifications, alternative constructions, and equivalents falling within the scope and spirit of the herein described systems and methods.

It should also be noted that the herein described systems and methods can be implemented in a variety of electronic environments (including both wired and wireless networked environments), partial computing environments, and other real world environments. The various techniques described herein may be implemented in hardware or software, or a combination of both. Preferably, the techniques are implemented in computing environments maintaining programmable computers that include a computer network, processor, servers, a storage medium readable by the processor (including volatile and non-volatile memory and/or storage elements), at least one input device, and at least one output device. Computing hardware logic cooperating with various instructions sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively the herein described apparatus and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The apparatus may also be considered to be implemented as a computer-readable storage medium, configured with a computer program, where the storage medium so configured causes a computer to operate in a specific and predefined manner.

Although exemplary implementations of the herein described systems and methods have been described in detail above, those skilled in the art will readily appreciate that many additional modifications are possible in the exemplary embodiments without materially departing from the novel teachings and advantages of the herein described systems and methods. Accordingly, these and all such modifications are intended to be included within the scope of the herein described systems and methods. The herein described systems and methods may be better defined by the following exemplary claims.

What is claimed is:

1. A system to generate and manage memory content comprising:
a memory content and management engine operable to receive data representative of one or more portions of a memory through one or more selected memory creation templates and/or data scraping operations; and
an instruction set comprising at least one instruction to instruct the memory content and generation engine to process the received data to generate memory content according to one or more selected memory content generation and management paradigms.

2. The system as recited in claim 1 further comprising a memory content data store capable of storing data representative of generated memory content.

3. The system as recited in claim 2 further comprising a user data store capable of storing data representative of user data.

4. The system as recited in claim 3 further comprising a memory content generation guidelines data store comprising data representative of memory content generation and management paradigms.

5. The system as recited in claim 4 further comprising a communications network operatively cooperating with he memory content and management engine to communicate data between the memory content and management engine and other cooperating parties.

6. The system as recited in claim 5 wherein the other cooperating parties comprise any of participating users.

7. The system as recited in claim 5 wherein the memory content generation and management engine comprises a computing environment.

8. The system as recited in claim 7 wherein the instruction set comprises a memory content generation and management computing application executable on the memory content generation and management computing environment.

9. The system as recited in claim 8 wherein the other cooperating parties comprise computing environments cooperating with memory content generation and management computing environment over the communications network.

10. The system as recited in claim 8 wherein the other cooperating parties comprise a user-generated advertisement platform.

11. A method to generate memory content comprising:
receiving data representative of one or more portions of a memory as inputs to one or more selected memory creation templates and/or data scraping operations; and
processing the received data according to a selected memory content generation paradigm to generate memory content.

12. The method as recited in claim 11 further comprising receiving the data representative of the one or more portions of a memory from a cooperating computing environment.

13. The method as recited in claim 12 further comprising communicating generated memory content to the cooperating computing environments.

14. The method as recited in claim 13 further comprising receiving data representative of one or more portions of memory as input to selected prompts.

15. The method as recited in claim 13 further comprising generating group memories.

16. The method as recited in claim 13 further comprising sharing generated memories according to a selected memory content sharing paradigm.

17. The method as recited in claim 13 further comprising generating a memory calendar from generated memory content.

18. The method as recited in claim 13 further comprising generating a memory map from generated memory content.

19. The method as recited in claim 13 further comprising generating a memory tree from generated memory content.

20. The method as recited in claim 11 further comprising associating additional content to generated memory content comprising any of news data, horoscope data, and digital media content.

21. A computer readable medium having computer readable instructions to instruct a computer to perform a method comprising:
receiving data representative of one or more portions of a memory as inputs to one or more selected memory creation templates and/or data scraping operations; and
processing the received data according to a selected memory content generation paradigm to generate memory content.

22. A system to generate memory content comprising:
a first means for receiving data representative of one or more portions of a memory as inputs to one or more selected memory creation templates and/or data scraping operations; and
a second mean for processing the received data according to a selected memory content generation paradigm to generate memory content.

23. The system as recited in claim 22 further comprising a third means for storing generated memory content.

24. The system as recited in claim 23 further comprising a fourth means for communicating generated memory content to participating users.

25. The system as recited in claim 24 comprising a fifth means for creating user-generated advertisements from generated memory content.

26. A method for managing content comprising:
digitizing data representative of one or more of yearbook data, roster data, and directory data to generate memory inputs;
receiving data representative of one or more portions of a memory as inputs to one or more selected memory creation templates; and
processing the received data according to a selected memory content generation paradigm to generate memory content.
